(19) United States
(12) Patent Application Publication
(10) Pub. No.: US 2014/0341872 A1
(43) Pub. Date: Nov. 20, 2014

(54) Use Of Lactic Acid Bacteria To Reduce Pathogens And As A Bio-Sanitizer

(71) Applicants: Douglas R. Ware, Chapel Hill, NC (US); Philip G. Crandall, Fayetteville, AR (US); Steven C. Ricke, Springdale, AR (US)

(72) Inventors: Douglas R. Ware, Chapel Hill, NC (US); Philip G. Crandall, Fayetteville, AR (US); Steven C. Ricke, Springdale, AR (US)

(73) Assignee: Guardian Food Technologies, LLC, Overland Park, KS (US)

(21) Appl. No.: 14/236,542

(22) PCT Filed: Jul. 31, 2012
(86) PCT No.: PCT/US12/49012

§ 371 Date: Jun. 9, 2014

Related U.S. Application Data
(60) Provisional application No. 61/513,851, filed on Aug. 1, 2011.

(51) Int. Cl. A01N 63/00; A23L 3/3571

(52) U.S. Cl. CPC A01N 63/00; A23L 3/3571; A23V 2002/00; A23Y 2280/15; A23Y 2220/05; A23Y 2220/07
USPC 424/93.45

(57) ABSTRACT

Compositions and methods are disclosed for improving food safety. One or more lactic acid producing microorganisms are shown to inhibit pathogenic contaminations on food materials. The lactic acid producing microorganisms are capable of adhering to various surfaces and may serve as a bio-sanitizing agent (or bio-sanitizer). Lactic acid producing microorganisms or cell free extract of these microorganisms may be used in an effective and natural method to prevent L. monocytogenes infection in food products, as well as in food processing facilities and equipments.

### RELATED APPLICATIONS

This application claims priority to U.S. Provisional Patent Application No. 61/513,851, filed Aug. 1, 2011 and entitled “LACTIC ACID BACTERIA AS A BIO-SANITIZER.” The aforementioned application is incorporated by reference into the present application in its entireties and for all purposes.

### BACKGROUND

I. Field of the Invention

The present disclosure relates to compositions and methods for improving food safety. More specifically, the disclosure relates to compositions and methods for reducing pathogen contamination during food production and processing by using lactic acid producing microorganisms to reduce the amount of pathogens in food products as well as in processing equipments or facilities.

II. Description of Related Art

Food contamination by pathogens is one of the biggest challenges for the food industry. Some pathogens may pose life-threatening risks to human and animals. Examples of food sources that are prone to contamination include meat, meat products, milk, seafood, seafood product, and plant materials such as leafy vegetables, certain fruits and products derived therefrom.

Pathogens that cause diseases in the intestinal tract are known as enteropathogens. Examples of enteropathogenic bacteria, or enterobacteria, include Staphylococcus aureus, various strains of Escherichia coli (E. coli), and Salmonella spp. Whereas many of the hundreds of strains of E. coli are harmless, some strains, such as E. coli O157:H7, O111:H8, and O104:H21, are virulent pathogens whose infections may be fatal if not treated properly. Another common pathogen is the bacterium Listeria monocytogenes, which has been implicated in numerous food-borne disease outbreaks. For review, see Tompkin, “Control of Listeria monocytogenes in the food-processing environment. J. Food Prot. 65:709-725 (2002).

Various measures have been developed to control contamination by these pathogens. For instance, certain strains of lactic acid bacteria have been shown to inhibit the growth of L. monocytogenes in meat products. See e.g., Amezquita and Brashears, “Competitive Inhibition of Listeria monocytogenes in Ready-to-Eat Meat Products by Lactic Acid Bacteria.” Journal of Food Protection, Vol. 65, No. 2, 2002, 316-325 (2002). However, pathogenic contaminations remain a big problem for the food industry. Certain pathogenic strains are difficult to remove because they can survive on various surfaces, including the surface of food products and food processing equipments. For example, some L. monocytogenes strains are able to adhere and form persistent biofilms on a variety of solid materials. See Farber and Peterkin, “Listeria monocytogenes, a food-borne pathogen.” Microbiol. Rev. 55:476-511 (1991).

### SUMMARY

The present instrumentalities advance the art by providing methods to improve food safety by using one or more lactic acid producing microorganisms and/or their cell-free supernatant to treat food and/or food processing equipments in order to reduce the amount of the pathogenic bacteria in the food material or food processing equipment. In one embodiment, the methods may include a step of contacting a surface with a composition that contains at least one lactic acid producing microorganism. The surface may be the interior or exterior surface of an object or a space. By way of example, the object or space may be a food material, a food processing equipment, a food processing platform, a food processing tool, a food processing room, a food container, or combination thereof.

In another embodiment, the amount of the at least one lactic acid producing microorganism present in the composition is an amount that is effective to prevent or disrupt formation of a biofilm by a pathogenic bacterium on the surface. In another aspect, the composition may also contain a cell-free supernatant of the at least one lactic acid producing microorganism. The composition may also inhibit growth of the pathogenic bacterium. In another aspect, the at least one lactic acid producing microorganism may also help reduce the amount of one or more non-bacterial pathogens.

In one embodiment, the at least one lactic acid producing microorganism may be one or more lactic acid bacteria (LAB). Examples of the LAB may include but are not limited to Lactobacillus acidophilus, Lactococcus lactis, Lactobacillus animalis, Lactobacillus cristpatus, Lactobacillus amylovorus, and Pediococcus acidilactici. In another embodiment, the lactic acid producing microorganism may include at least two, or at least three different species selected from the group consisting of Lb. acidophilus, Lc. lactis, Lb. animalis, Lb. cristpatus, Lb. amylovorus, and P. acidilactici.

In another embodiment, the composition of the present disclosure contains at least one LAB which may inhibit the proliferation of one or more pathogens. Examples of the pathogens include but are not limited to E. coli, Staphylococcus aureus, Listeria monocytogenes, Campylobacter jejuni, Clostridium botulinum, Clostridium sporogenes, and Salmonella typhimurium. In one aspect, the E. coli may be the E. coli O157:H7 strain.

In another embodiment, the at least one lactic acid producing microorganism may be one or more strains belonging to the same or different species. Examples of such strains include but are not limited to NP35 (also known as M35), LA45, NP51 (also known as LA51), L411, NP3 (also known as D3) and NP7. NP35 belongs to the species of Lb. amylovorus, while NP3 belongs to the species of P. acidilactici. In another embodiment, the composition contains at least the following three strains NP51, NP35, and NP3. In another embodiment, the composition contains the following three strains NP51, NP35, and NP3, with no or only negligible amount of other strains. The three strains may be present at different ratio. In one aspect, the ratio between the three strains, NP51, NP35, and NP3 is 1:1:2, as measured by colony formation unit (CFU). In another aspect, the ratio between the three strains, NP51, NP35, and NP3 is about 1:1:1, 2:1:1, 1:2:1, or 2:2:1. It is to be understood that variation of CFU is common for live cultures. Thus, variations of CFU by up to about 50% is still considered within the scope of the disclosed ratio. For instance, a CFU ratio of about 1.2:1:0.8 is considered within the scope of the ratio of about 1:1:1.

In another embodiment, the disclosed composition may be in the form of a liquid. In one aspect, the amount of the at least one lactic acid producing microorganism in the composition may be from 1×10³ to 1×10¹⁰ CFU/ml, or from 1×10⁴ to 1×10⁸ CFU/ml. In another aspect, the amount of the at least one lactic acid producing microorganism in the composition is about 1×10⁶ CFU/ml, about 1×10⁷ CFU/ml, about 1×10⁸ CFU/ml, or about 1×10⁹ CFU/ml. When the composition contains different microorganisms, the CFU is calculated by adding the CFUs of each microorganism. When cell-free supernatant (CFS) is used, the supernatant obtained directly from the lactic acid producing microorganism is considered as the original CFS (1:1).

In another embodiment of the present disclosure, the amount of the at least one lactic acid producing microorganism in the composition may be an amount of the lactic acid producing microorganism(s) that is sufficient to form a layer of film after being applied to the surface. In one aspect, at least 3% of the lactic acid producing microorganisms are attached to the surface within 72 hours after being applied to the surface. In another aspect, at least 5%, 10%, or 15% of the lactic acid producing microorganisms are attached to the surface within 72 hours after being applied to the surface.

The lactic acid producing microorganism(s) of the instant disclosure may inhibit the proliferation (or replication) of various pathogenic bacteria. In one embodiment, the amount of the at least one lactic acid producing microorganism in the composition may be an amount of the lactic acid producing microorganism(s) that reduces the total number of a Listeria bacterium, such as L. monocytogenes on the surface of an object. By way of example, the amount of the at least one lactic acid producing microorganism may be an amount that reduces the number of Listeria bacteria by an order of at least 1 log, or at least 2 log, at a temperature ranging from 0-25° C. The log reduction may be measured by comparing the total number of Listeria in the presence of a certain amount of the lactic acid producing microorganism(s) with the total number of the same Listeria in the absence of the lactic acid producing microorganism(s).

The lactic acid producing microorganism(s) of the instant disclosure may reduce the number of pathogens on a surface by inhibiting both the proliferation (or replication) and attachment of the pathogens. In one embodiment, the amount of the at least one lactic acid producing microorganism in the composition may be an amount of the lactic acid producing microorganism(s) that inhibits both the proliferation and the attachment of Listeria bacterium. By way of example, the composition may contain one or more LABs that reduce the proliferation rate of a Listeria bacterium by at least 20%, 40%, 50%, or even 60% or more. In another aspect, the composition may contain one or more LABs that inhibit the attachment by the same Listeria bacterium by at least 20%, 40%, 50%, or even 60% or more.

The composition of the present disclosure may be caused to be in contact with the surface of the object or space before, during, or after the use of the object or space for food processing. In one aspect, the LABs in the composition may be applied to the surface before the surface has been exposed to a pathogen. The presence of the LAB may interfere with the attachment of the pathogen. In one aspect, the composition may decrease the attachment of a Listeria bacterium to a surface by one log, or two log, when the composition containing at least one LAB is applied to the surface 1 hour, 8 hours, 12 hours, or 24 hours before the surface is or may be exposed to the Listeria bacterium.

In another aspect, the disclosed composition may be applied to the surface after the surface has been exposed to a pathogen. The LABs in the composition may disrupt the attachment of the pathogen to the surface. Alternatively, the LABs in the composition may inhibit proliferation of the pathogen. In one aspect, the composition may decrease the attachment of a Listeria bacterium to a surface by one log, or two log, when the composition containing at least one LAB is applied to the surface 1 hour, 8 hours, 12 hours, or 24 hours after the surface is exposed to the Listeria bacterium.

The composition may be in the form of a liquid, a suspension, a solution, a powder and may be applied to the surface by spraying, sprinkling, wiping, misting, soaking, rinsing, or any other methods for distribution of liquid or powders to an object having a surface area.

The composition may be applied every 4 hours, every 8 hours, twice a day, once a day, once a week, at other intervals deemed effective in reducing pathogenic infection.

In another aspect of the present disclosure, the amount of the LABs in the composition may be an amount of the LABs that is effective in reducing the total number of the pathogen(s) to below 10³ CFU, 10² CFU, 10¹ CFU, or even more preferably, to 0 CFU per square feet after the composition is caused to be in contact with the surface for 24 hours, or longer. In another aspect, the amount of the LABs in the composition may be an amount of the LABs that is effective in reducing the total number of the pathogen(s) to below 10⁴ CFU, 10³ CFU, 10² CFU, 10¹ CFU, or even more preferably, to 0 CFU per kg of the food material after the composition is caused to be in contact with the surface of the food material for 24 hours, or longer.

In another aspect, the composition may be caused to be in contact and remain in contact with a surface at the temperature under which the object or space is typically maintained. Alternatively, the composition may be caused to be in contact with the surface of an object or space after which the temperature of the object or space is adjusted to a temperature between 0 and 30° C., between 0 and 20° C., or between 4 and 10° C., for at least 30 minutes, 4 hours, 8 hours, 24 hours, or longer.

The surface may be kept under normal or controlled atmospheric conditions after being in contact with the composition containing the LABs. Under certain circumstances, it may be desirable to modify the atmospheric condition such that the controlled atmosphere contains about 80% oxygen and about 20% carbon dioxide. Alternatively, the controlled atmosphere may contain about 80% nitrogen and about 20% carbon dioxide.

The present disclosure also provides a method for reducing the amount of one or more pathogens in a food material. In one embodiment, a composition may be caused to be in contact with a food material. The composition may contain at least one lactic acid producing microorganism which is present in the composition in an amount that is effective in reducing the number of the pathogen(s) in the food material. The composition may contain one or more lactic acid producing bacteria selected from the group consisting of NP3 (also referred to as D3), NP35 (also referred to as M35), NP51 (also referred to as LA51) and combination thereof. In one aspect of the disclosure, the pathogen is Listeria monocytogenes. In another aspect, the composition contains the lactic acid producing microorganism NP3.

The effective amount may be an amount of the lactic acid producing microorganism that is capable of reducing the number of such pathogenic bacterium in the food material by at least 2 logs within 24 hours after contact. In another aspect, the lactic acid producing microorganism is capable of reducing the number of the pathogenic bacterium in the food material by at least 3 logs, 4 logs or 5 logs, within 24 hours after contact. By way of example only, if the food material contains a pathogenic bacterium at 10⁴ CFU per kg of food material, a reduction by 3 logs means that the pathogen content will be reduced to 10 CFU per kg or lower after 24-hour incubation with the composition of the instant disclosure.

In another embodiment, food material may be caused to be in contact with a composition, containing a cell-free supernatant (CSF) obtained from at least one lactic acid producing microorganism. The CSF may be present in the composition in an amount effective in reducing the number of pathogen or pathogens in the food material. In one aspect, the CSF may be diluted by at least 1:50, 1:100, or even 1:512 fold before being in contact with the food material.

### BRIEF DESCRIPTION OF THE DRAWINGS

FIG. 1 shows the result of a hydrophobicity study of L. monocytogenes, individual LABs P. acidilactici, Lb. amylovorus, and Lb animalis, and LAB cocktail with all three strain in a 2:1:1 ratio. Bars with different alphabetic notations differ significantly (P<0.05).

FIG. 2 shows total carbohydrate production of L. monocytogenes and LAB strains in planktonic cells (cells suspended in PBS) and attached cells (after 3 hr of attachment of to stainless steel surface at 23° C.). Total carbohydrate is given in mg of carbohydrate per log CFU per milliliter (planktonic) or cm² (attached). Carbohydrate produced by the attached cells were significantly higher than planktonic (p<0.05).

FIG. 3 shows attachment of L. monocytogenes (10³ CFU/ml), P. acidilactici, Lb. amylovorus, Lb animalis (10⁸ CFU/ml each), and the combination of the three strains (LAB cocktail, 10⁸ CFU/ml) on stainless steel coupons at 23° C. for 24 and 72 hr. Asterisk shows the significant difference (P<0.05).

FIG. 4 shows inhibition of the attachment of L. monocytogenes (10³ CFU/ml) by LAB (10⁸ CFU/ml) on stainless steel.

FIG. 5 shows competitive attachment inhibition between L. monocytogenes (10³ CFU/ml) and LAB (10⁸ CFU/ml) on stainless steel.

FIG. 6 shows displacement of L. monocytogenes (10³ CFU/ml) by LAB (10⁸ CFU/ml) on stainless steel.

FIG. 7 shows comparison of L. monocytogenes inhibition by P. acidilactici across four temperatures.

FIG. 8 shows L. monocytogenes recovered from lactic acid bacteria (LAB) cell free supernatant (CFS) incubated at 7° C. over the course of 21 days.

FIG. 9 shows lactate production by the three lactic acid bacteria (LAB) strains tested. Data shown indicate the average lactate produced in nmol/μl and error bars their corresponding standard deviations.

FIG. 10 shows protease- and heat-stability of P. acidilactici cell free supernatant (CFS) antilisterial activity after the following treatments: autoclaving (121° C. and 15 psi) for 15 min (A); room temperature for 15 min (B); room temperature for 1 h (C); and 25mg/ml proteinase K for 1 h (D).

### DETAILED DESCRIPTION OF THE INVENTION

The present disclosure provides methods for reducing the pathogen content on a surface of food materials or a surface that is likely to be in contact with food. The methods include contacting the surface with a composition containing one or more lactic acid producing microorganisms.

For purpose of this disclosure, the term “food” or “food material” may be used to refer to anything that are edible. In one embodiment, food may include but is not limited to meat, a meat product, seafood, a seafood product, a plant material, milk from an animal, milk derived from a plant material, or combination thereof. Food can be in the form of a solid, a liquid, a paste, a powder, a suspension, or mixture thereof. The term “food processing” may refer to any process of harvesting, treating, milking, slaughtering, cutting, processing, dividing, packaging of food or food materials.

Enhanced inhibition and/or exclusion of pathogens may be achieved with the administration of multiple LAB strains, or with the administration of one or more LAB strains in combination with certain chemicals. Similarly, advantageous effects may be achieved, for example, by multiple or repetitive contacts (a chain of contacts) of the surface with the LAB microorganisms.

While not limited by any scientific theory or mode of action, natural competition of certain microorganisms with pathogenic microorganisms may reduce or eliminate enterobacteria. Microorganisms disclosed herein may act in various ways. For example, the microorganisms may act as a bacteriocin or may act by producing bacteriocins. They may inhibit one or more pathogens by competing for nutrients and/or attachment spaces with the pathogen. They may also interfere with biofilm formation by certain pathogens, such as Listeria.

As used herein, a method of contacting the surface with a composition may mean applying the composition directly or indirectly to the surface or bringing the surface to be in tough with the composition. In various aspects, a composition may be directly applied as a spray, a rinse, or a powder, or any combination thereof. As used herein, a spray refers to a mist of liquid particles that contain a composition of the present disclosure. A spray may be applied directly to the surface using items including, but not limited to, a spray can, a spray bottle, a spray gun. The composition of the present disclosure may be distributed initially as a liquid but may turn into a gas at room temperature and pressure.

The terms “lactic acid producing bacteria (or microorganisms)” and “lactic acid bacteria (or microorganisms)” may be used interchangeably in this disclosure and are sometimes abbreviated as “LAB.” Unless otherwise specified, the term CFU in this paragraph refers to the colony forming unit of a microorganism capable of forming colonies on solid media.

A contacting step may occur while surface is being used, before or after use, while a food material is being processed, while a food material is being packaged, or while a food material is being stored in warehouse or on the shelf of a store.

A composition as used herein may be in the form of a liquid, an aerosol, a heterogeneous mixture, a homogeneous mixture, a powder, or a solid dissolved in a solvent. As used herein, the term “liquid” means a substance in the fluid state of matter having no fixed shape. In a further aspect, the composition may be a solution. In a solution, a solute is dissolved in a second substance commonly known as a solvent.

As described above, the term “powder” refers to a composition that is a dry or nearly dry bulk solid composed of a large number of very fine particles that may flow freely when shaken or tilted. A dry or nearly dry powder composition of the present invention preferably contains a low percentage of water, such as less than 5%, less than 2.5%, or less than 1% by weight.

In a further aspect, the composition of the present disclosure may be a suspension. A suspension is a heterogeneous mixture containing solid particles that are sufficiently large for sedimentation. Particles in a suspension are visible under a microscope and will settle over time if left undisturbed.

In a further aspect of the present disclosure, the composition may be an emulsion. As used herein, the term “emulsion” means a mixture of two immiscible liquids.

In yet another aspect, the composition of the present disclosure may be a colloidal dispersion. A colloidal dispersion is a type of chemical mixture where one substance is dispersed evenly throughout another. Particles of the dispersed substance are only suspended in the mixture, unlike a solution, where they are completely dissolved within. This occurs because the particles in a colloidal dispersion are larger than in a solution—small enough to be dispersed evenly and maintain a homogenous appearance, but large enough to scatter light and not dissolve. Colloidal dispersions are an intermediate between homogeneous and heterogeneous mixtures and are sometimes classified as either “homogeneous” or “heterogeneous” based upon their appearance.

The lactic acid producing microorganisms of the present invention include any microorganism capable of producing lactic acid. In one aspect, the lactic acid producing microorganism is selected from the group consisting of: Bacillus subtilis, Bifidobacterium adolescentis, Bifidobacterium animalis, Bifidobacterium bifudum, Bifidobacterium infantis, Bifidobacterium longum, Bifidobacterium thermophilum, Lactobacillus acidophilus, Lactobacillus agilis, Lactobacillus alactosus, Lactobacillus alimentarius, Lactobacillus amylophilus, Lactobacillus amylovorans, Lactobacillus amylovorus, Lactobacillus animalis, Lactobacillus batatas, Lactobacillus bavaricus, Lactobacillus bifermentans, Lactobacillus bifidus, Lactobacillus brevis, Lactobacillus buchnerii, Lactobacillus bulgaricus, Lactobacillus catenaforme, Lactobacillus casei, Lactobacillus cellobiosus, Lactobacillus collinoides, Lactobacillus confusus, Lactobacillus coprophilus, Lactobacillus coryniformis, Lactobacillus corynoides, Lactobacillus crispatus, Lactobacillus curvatus, Lactobacillus delbrueckii, Lactobacillus desidiosus, Lactobacillus divergens, Lactobacillus enterii, Lactobacillus farciminis, Lactobacillus fermentum, Lactobacillus frigidus, Lactobacillus fructivorans, Lactobacillus fructosus, Lactobacillus gasseri, Lactobacillus halotolerans, Lactobacillus helveticus, Lactobacillus heterohiochii, Lactobacillus hilgardii, Lactobacillus hordniae, Lactobacillus inulinus, Lactobacillus jensenii, Lactobacillus jugurti, Lactobacillus kandleri, Lactobacillus kefir, Lactobacillus lactis, Lactobacillus leichmannii, Lactobacillus lindneri, Lactobacillus malefermentans, Lactobacillus mali, Lactobacillus maltaromicus, Lactobacillus minor, Lactobacillus minutus, Lactobacillus mobilis, Lactobacillus murinus, Lactobacillus pentosus, Lactobacillus plantarum, Lactobacillus pseudoplantarum, Lactobacillus reuteri, Lactobacillus rhamnosus, Lactobacillus rogosae, Lactobacillus tolerans, Lactobacillus torquens, Lactobacillus ruminis, Lactobacillus sake, Lactobacillus salivarius, Lactobacillus sanfrancisco, Lactobacillus sharpeae, Lactobacillus trichodes, Lactobacillus vaccinostercus, Lactobacillus viridescens, Lactobacillus vitulinus, Lactobacillus xylosus, Lactobacillus yamanashiensis, Lactobacillus zeae, Pediococcus acidlactici, Pediococcus pentosaceus, Streptococcus cremoris, Streptococcus discetylactis, Streptococcus faecium, Streptococcus intermedius, Streptococcus lactis, Streptococcus thermophilus, and combinations thereof. In one aspect, the lactic acid producing microorganism is selected from the group consisting of Lactobacillus acidophilus, Lactococcus lactis, and Pediococcus acidilactici. In another aspect, the lactic acid producing microorganism is Lactobacillus acidophilus.

NP51 (a.k.a. LA51) may be referred to as Lactobacillus acidophilus/animalis or Lactobacillus animalis because when strain NP51 was first isolated, it was identified as a Lactobacillus acidophilus by using an identification method based on positive or negative reactions to an array of growth substrates and other compounds (e.g., API 50-CHL or Biolog test). Using modern genetic methods, however, strain NP51 has recently been identified as belonging to the species Lactobacillus animalis (unpublished results).

Lactobacillus amylovorus M35 (a.k.a. NP35), LA45, and NP51 were deposited with the American Type Culture Collection (ATCC, Manassas, Va. 20110-2209) on May 26, 2005 and have the Deposit numbers of PTA-6751, PTA-6749, and PTA-6750, respectively. Lactobacillus acidophilus strain L411 was deposited with the American Type Culture Collection (ATCC, Manassas, Va. 20110-2209) on Jun. 30, 2005 and has the Deposit number of PTA-6820. Pediococcus acidilactici D3 (a.k.a. NP3) was deposited with the American Type Culture Collection (ATCC, Manassas, Va. 20110-2209) on Mar. 8, 2006 and has the Deposit number of PTA-7426. These deposits were made in compliance with the Budapest Treaty requirements that the duration of the deposit should be for thirty (30) years from the date of deposit or for five (5) years after the last request for the deposit at the depository or for the enforceable life of a U.S. patent that matures from this application, whichever is longer. The strains will be replenished should it become non-viable at the depository.

The various aspects of the present disclosure include application of a composition to a surface of an object or a space. The composition may contain different microorganisms, different strains, or a combination of any number of different microorganisms and different strains. For example, one, two, three, four, five, six, or more microorganisms may be used. In another aspect, one, two, three, four, five, six, or more strains of the same microorganism may be used. Different microorganisms may be added sequentially to the same surface, or may be prepared as a “cocktail” before being applied to the surface.

As used herein, the term “one or more” may mean any integer equal or greater than one, and may include one, two, three, four, and so on. In one embodiment, “one or more” may mean from one to ten.

It is to be noted that, as used in this specification and the claims, the singular forms “a,” “an,” and “the” include plural referents unless the context clearly dictates otherwise. Thus, for example, reference to “a pathogen” includes reference to a mixture of two or more pathogens, reference to “a lactic acid producing bacterium” includes reference to bacterial cells that are lactic acid producing bacteria.

The terms “from,” “to,” “between,” and “at least” as used herein are inclusive. For example, a range of “between 5 and 10” means any amount equal to or greater than 5 but equal to or smaller than 10.

As used herein, the term pathogen refers to a biological agent that causes disease or illness to a host. A pathogen may be a bacterium, a virus, or a fungus, and may be active or dormant. In one aspect of the present disclosure, a pathogen is a bacterium. In another aspect, a bacterium is an enteropathogenic bacterium, or enteropathogen. In one aspect, the pathogen may be a pathogenic E. coli, a pathogenic Staphylococcus, a pathogenic Listeria, a pathogenic Shigella, a pathogenic Campylobacter, a pathogenic Clostridium, a pathogenic Mycobacterium, a pathogenic Yersinia, a pathogenic Bacillus, a pathogenic Vibrio, a pathogenic Streptococcus, a pathogenic Aeromonas, a pathogenic Klebsiella, a pathogenic Enterobacter, a pathogenic Citrobacter, a pathogenic Aerobacter, a pathogenic Serratia, and a pathogenic Salmonella. In another aspect, the pathogen can be and includes E. coli O157:H7, Staphylococcus aureus, Listeria monocytogenes, Campylobacter jejuni, or Salmonella Typhimurium. In one embodiment, the pathogen may be E. coli O157:H7. In another embodiment, the pathogen may be a Listeria.

A method of the present disclosure may affect the pathogen content on a surface of living or non-living matters. In one aspect, pathogen content refers to the number of pathogens in a food material. In another aspect, pathogen content refers to the number of pathogens in a sample of a food material. In another aspect, pathogen content refers to the number of pathogens in a sub-sample of a food material. The terms “in” and “on” as used herein, for example, in the phrase “in a food material,” means that a subject such as a pathogen is located inside, or on the surface of another subject, such a food material. It is to be understood that because pathogen may grow and expand its territory, a pathogen that initially resides on the surface of a material may grow and expand into the inside of the material.

In another aspect, the pathogen content of a surface after a contacting step is preferably less than the pathogen content of the same surface before the contacting step. In one aspect, the term “less than” may mean having fewer number of total pathogen cells on a surface. In another aspect, “less than” may mean having fewer number of pathogen species on a surface. In a further aspect, “less than” may mean having fewer number of viable pathogens on a surface. As used herein, a decrease is defined as having lower number of pathogens than were on the surface before treatment of the surface with the disclosed composition. In one aspect, the lower number of pathogens is a lower number of viable pathogens or pathogens capable of replicating. In another aspect, a decrease can be and includes a reduction of at least about 5%, at least about 10%, at least about 20%, at least about 30%, at least about 40%, at least about 50%, at least about 60%, at least about 70%, at least about 80%, at least about 90%, at least about 95%, at least about 99%, at least about 99.9%, at least about 99.99%, or ideally 100%.

In a further aspect, affecting the pathogen content results in inhibition of further pathogen growth. In one aspect, pathogen growth is defined as the division of one pathogen cell into two daughter cells. In another aspect, inhibition results in stopping the growth of pathogens on a surface so that the total number of pathogens on the surface remains the same. In another aspect, inhibition results in slowing the growth of pathogens on the surface. Slowing of pathogen growth can occur during the exponential phase of growth and results in a lower number of cell divisions per unit time as compared to a surface not treated with the methods of the present disclosure.

In one aspect, inhibition of pathogen growth occurs immediately. In another aspect, inhibition of pathogen growth occurs one minute after, 30 minutes after, 45 minutes after, one hour after, two hours after, four hours after, six hours after, twelve hours after, eighteen hours after, one day, 3 days, or one week after the disclosed composition is applied to the surface.

For the methods described herein, a reduction in pathogen content or concentration on the surface is achieved relative to a control. Reduction of pathogens may be measured using methodology commonly used in the art. In one aspect, pathogen concentrations are measured in colony forming units (CFU) obtained from a fixed quantity of material or from a fixed area of surface. For example, the reduction in the number of CFU can be at least about 5%, at least about 10%, at least about 20%, at least about 30%, at least about 40%, at least about 50%, at least about 60%, at least about 70%, at least about 80%, at least about 90%, at least about 95%, at least about 99%, at least about 99.9%, at least about 99.99%, or ideally about 100%. The reduction can also be ranges between any two of these values. Alternatively, the reduction can be measured in “log cycles.” Each log reduction (also referred to as log CFU or logᵢₙ CFU when referring to the reduction in CFU of a pathogen) in concentration is equal to a ten-fold reduction (e.g. a one log reduction is a ten-fold reduction; a two log reduction is a 100-fold reduction, and so on.). The log cycle reduction can be at least about 0.5, at least about 1, at least about 1.5, at least about 2, at least about 2.5, at least about 3, at least about 3.5, at least about 4, and ranges between any two of these values. Log cycle reductions can be easily converted to percent reduction. A 1 log cycle reduction is equal to 90%, a 2 log cycle reduction is equal to 99%, a 3 log cycle reduction is equal to 99.9%, and so on.

Viability of the pathogen can also be measured. In one aspect, viability can be measured by a physical measurement, a chemical measurement, a measurement of chemical activity, or a measurement of turbidity. In another aspect, viability is measured by quantifying colony forming units (CFU) obtained from a fixed quantity of a material or fixed area of the surface.

One-way ANOVA with Tukey HSD means comparison was performed where appropriate to determine statistical significance. Statistical analyses were performed using JMP 7 (SAS Institute Inc, Cary, N.C.).

The Examples below are provided to illustrate but not to limit the present invention. Those of skill in the art should, in light of the present disclosure, appreciate that many changes may be made in the specific aspects which are disclosed within the following examples and elsewhere and still obtain a like or similar result without departing from the scope of the invention.

### EXAMPLES

### Example 1

### Hydrophobicity of Lactic Acid Bacteria

In order to evaluate the ability of LAB s to competitively exclude L. monocytogenes by forming biofilm, the hydrophobicity of several LAB strains was evaluated to determine the potential effect of bacterial physiochemical properties on attachment (Nira et al, 2010). Previous studies have shown that more hydrophobic cells tend to attach better to various surfaces. It has also been shown that hydrophobicity of a bacterium may correlate with its capability to form stable attachment to the surface of food, such as deli meat (Bonaventura et al, 2007).

Each culture of the LABs and Listeria monocytogenes was grown from stock, streaked on solid media and incubated at 37° C. for 24 h for isolation of single colonies. Tryptic soy agar with 0.6% yeast extract (TSAYE) was used for L. monocytogenes and de Man, Rogassa and Sharp (MRS) agar was used for individual NP3, NP35 and NP51 strains. A single colony was placed in individual 5 ml tubes of TSAYE or MRS and incubated at 37° C. for 18 to 20 h. A 3-strain combination which contains all three strains, NP3, NP35 and NP51, was thawed from a commercially available packet and used directly.

About 2 ml of bacterial cells were harvested by centrifugation and washed twice with phosphate buffered saline (PBS). The cells were then resuspended in water to an absorbance (wavelength of 620 nm) of about 1.0. Then, 1 ml of n-Hexadecane was added to 1 ml of bacterial cell suspension and incubated at 30° C. for 10 min. The solution was mixed by vortexing for 60 seconds and the suspension was incubated for 15 min until the hydrocarbon phase rose completely to the top. Optical density of the aqueous phase of the suspension was measured at 620 nm and was compared to the bacterial suspension before mixing with hexadecane. The hydrophobicity of bacteria adhering to hexadecane was calculated by the equation:

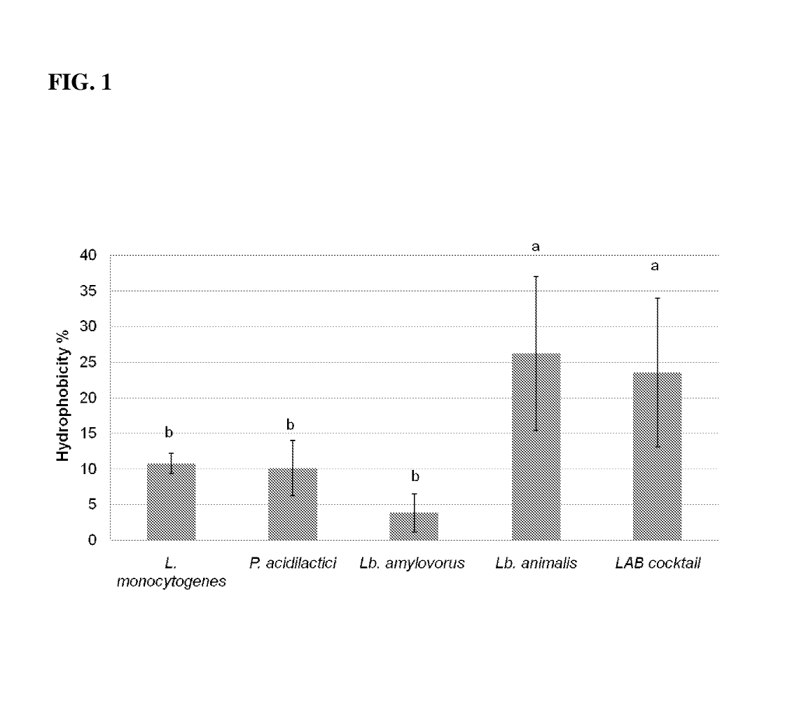

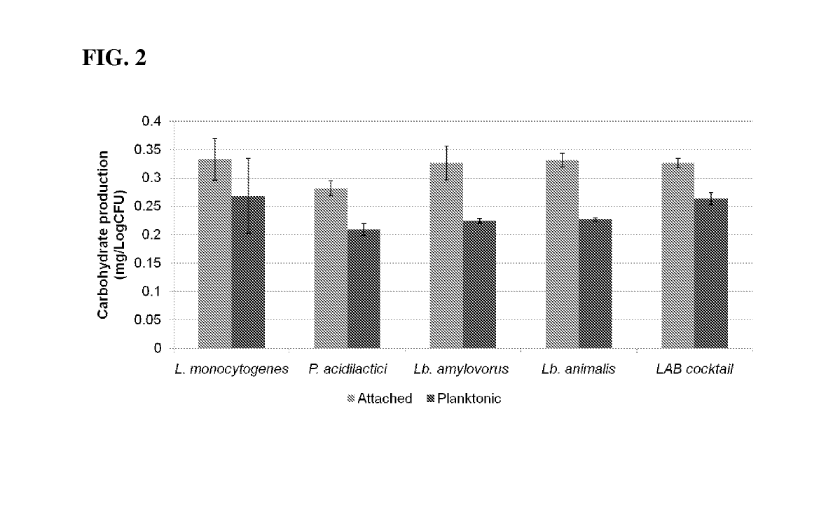

H %=((OD_{620 I}−OD_{620 H})/OD_{620 I})*100

wherein OD_{620 I} is the initial OD₆₂₀ before mixing with hexadecane, and OD_{620 H} is the OD₆₂₀ of the aqueous phase after mixing with hexadecane. The results of the hydrophobicity tests are shown in FIG. 1. X axis is strain of bacteria, y axis is % hydrophobicity. Each bar represents the average of 3 experiments. Error bars indicate standard deviation from the mean. Lm191 is L. monocytogenes, and LG and LgMIX are mixture of the three LAB NP3, NP35 and NP51. Lb. animalis NP51 exhibited the highest hydrophobicity with about 26% while Lb. amylovorus NP35 exhibited the lowest hydrophobicity among all strains tested at about 2.5% hydrophobicity.

### Example 2

### Measurement of Total Carbohydrate Production

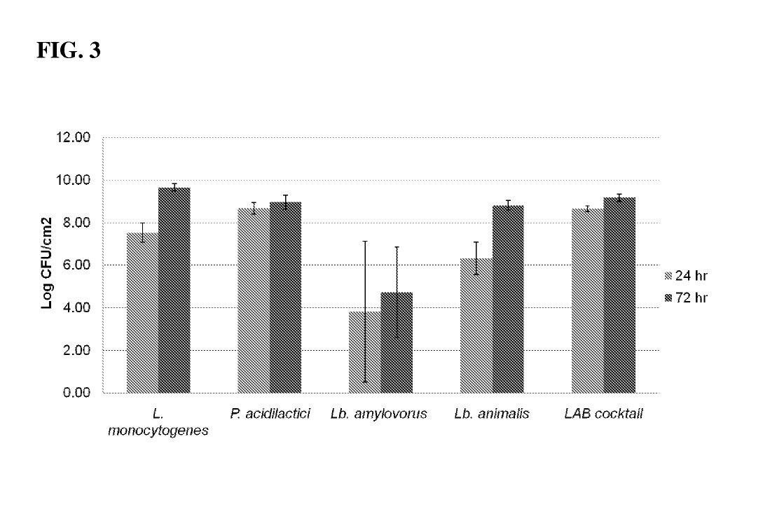

Total carbohydrate production: L. monocytogenes and LAB strains were grown to stationary phase, washed by centrifugation three times and resuspended to an Abs 600 nm=0.32±0.04. The cell suspensions were deposited on sterile stainless steel coupons and were incubated at 23° C. for 3 hr. The attached cells were removed using a swab that was subsequently placed into PBS. The total carbohydrate produced by the bacteria was determined from the supernatant of the attached cell, and the planktonic cultures using phenol-sulfuric acid method (Chae et al., 2006). As shown in FIG. 2, the attached cells produced significantly higher carbohydrate than planktonic cells.

### Example 3

### Inhibition or Exclusion of Listeria Attachment on Stainless Steel by LAB

Attachment of individual LAB strains and the 3-strain combination to stainless steel coupons was evaluated. The coupons were from a donated deli slicer which was cut into coupons measuring 2×2.5 cm using a Flow Waterjet Cutting System (Flow International Corporation, Kent, Wash.) at C. Mayo Sheet Metal. The coupons were washed, and autoclaved at 121° C. for 15 min before use.

Attachment/adherence of individual LAB strains (10⁸ CFU/ml) as well as the 3-strain combination to stainless steel coupons were tested. The 3-strain combination, at 10⁸ cells/well, was prepared and incubated at 23° C. for three hours to allow the bacteria to attach to the coupons. Bacterial cells were prepared as described previously in Example 1. Individual LAB strains, NP35, NP51 and NP3, as well as the 3-strain combination, were placed in separate wells of a 6-well plate. The concentration of the bacteria was about 10⁸-10⁹ CFU/well. Stainless steel coupons were added to the 6 well plates. TSBYE were used as the culture media because both L. monocytogenes and the LAB strains can grow in the media. TSBYE was also used for the competitive exclusion assay.

After incubation, the coupons were washed with 1 ml PBS three times, transferred to new 6 well plates containing fresh TSBYE. The plates were incubated at 23° C. for 24 and 72 h, respectively, and at 7° C. for 72 h and 7 days, respectively. The coupons were then recovered aseptically and washed three times with 1 ml PBS. Each coupon was transferred to different 50 ml sterile centrifuge tubes and 15 ml PBS was added to each tube. The attached cells were released by sonicating the coupons for 3 min (2sec pulse on/1 sec off) and plated on MRS agar by serial dilution. The plates were incubated at 37° C. for 48 hours and the numbers of colonies were enumerated for each plate.

FIG. 3 shows attachment of individual strains, L. monocytogenes (10³ CFU/ml), P. acidilactici, Lb. amylovorus, Lb animalis (10⁸ CFU/ml each), and the combination of the three strains (LAB cocktail, 10⁸ CFU/ml) on stainless steel coupons at 23° C. for 24 and 72 hr. X axis is name of bacterial strains. Y axis is colony forming units (CFU) of bacteria per milliliter of culture. Green bars are results after 24 hours incubation, blue bars after 72 hours. All three individual strains and the 3-strain combination showed strong adherence to stainless steel.

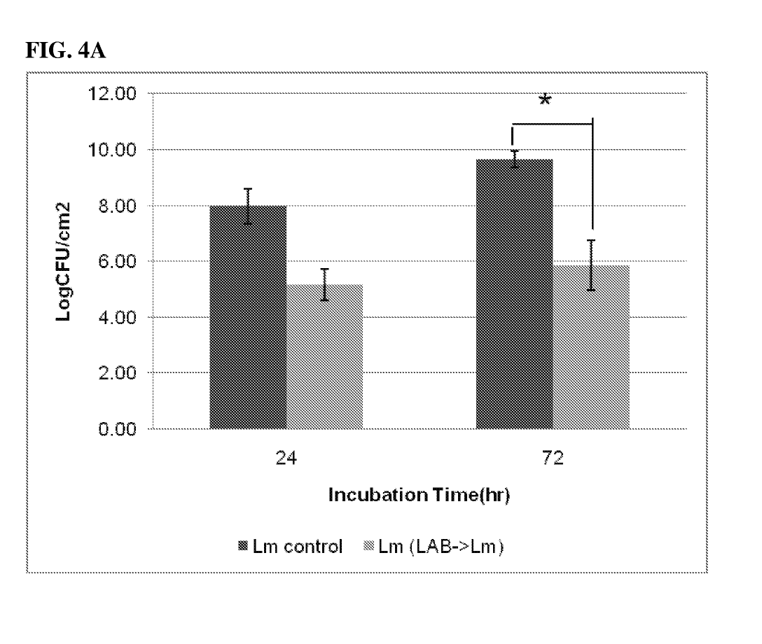

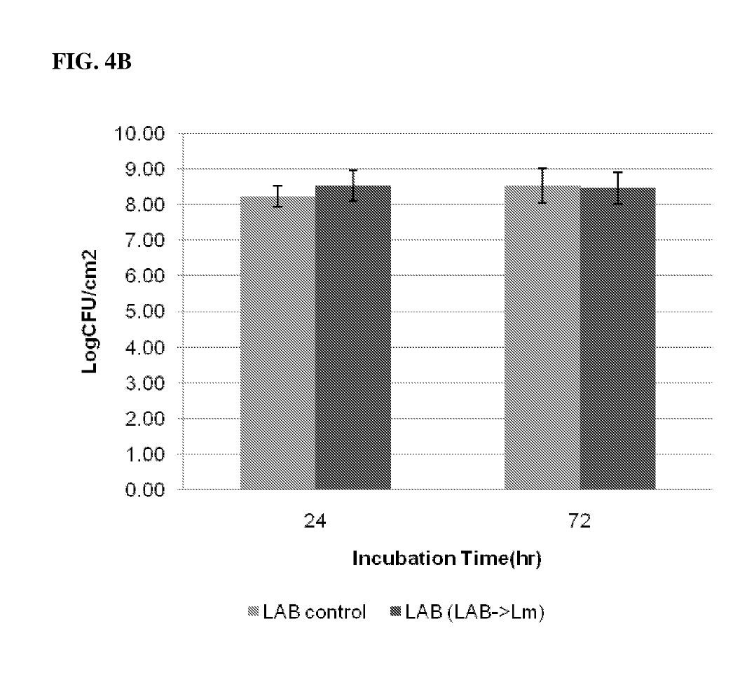

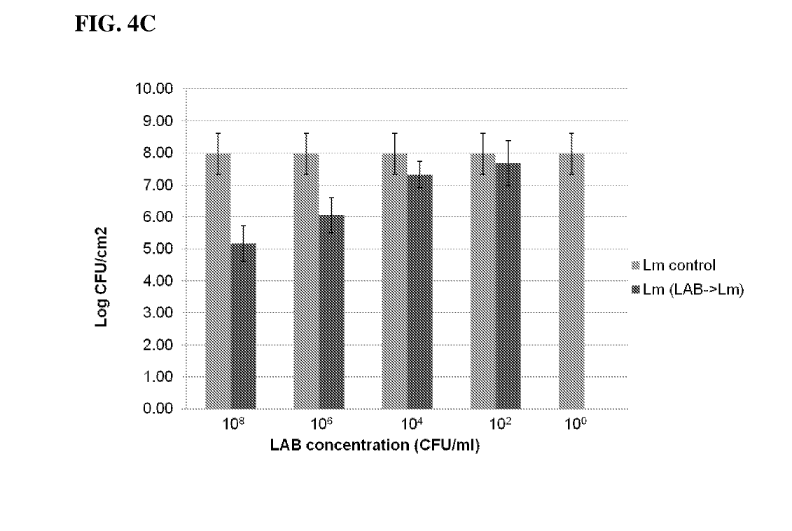

Inhibition of the attachment of L. monocytogenes (10³ CFU/ml) by LAB (10⁸ CFU/ml) on stainless steel is shown in FIG. 4. LAB was allowed to attach to the coupons for 24 hr prior to the addition of L. monocytogenes. FIG. 4A shows the amount of L. monocytogenes remained after 24 and 72 hr incubation. Lm (LAB→Lm) indicates the amount of L. monocytogenes when the coupons were pre-treated with LAB for 24 hr. Incubation time is considered from the time after L. monocytogenes inoculation. FIG. 4B shows the amount of LAB remained after 24 and 72 hr incubation. LAB (LAB→Lm) indicates the amount of LAB when L. monocytogenes was added. FIG. 4C shows the limit of attachment inhibition by different concentration of LAB. Lm (LAB→Lm): L. monocytogenes attached to the coupons when pre-treated with LAB (10⁸, 10⁶, 10⁴, 10² CFU/ml). Asterisk shows the significant difference (P<0.05). X axis=time, y axis=Log CFU/ml of L. monocytogenes. Blue bars are L. monocytogenes only (control), red bars L. monocytogenes+LAB.

For the competitive-exclusion assay, the steps described above for the incubation of the LABs with the coupons were followed until the coupons were washed three times with 1 ml of PBS. The coupons were placed in a new 6 well plate with fresh TSBYE and L. monocytogenes was added at 10³-10⁴ cells/well. The 6-well plates were incubated for three hours at 23° C. to allow for the attachment of L. monocytogenes to the coupons. Bacterial cells were washed again, transferred to new plates and incubate for 3 days at 23° C. Then the coupons were washed and sonicated to release the cells. The cells were plated on MRS for LABs and modified oxford agar (MOX) for L. monocytogenes and the plates were incubated at 37° C. for 48 hours.

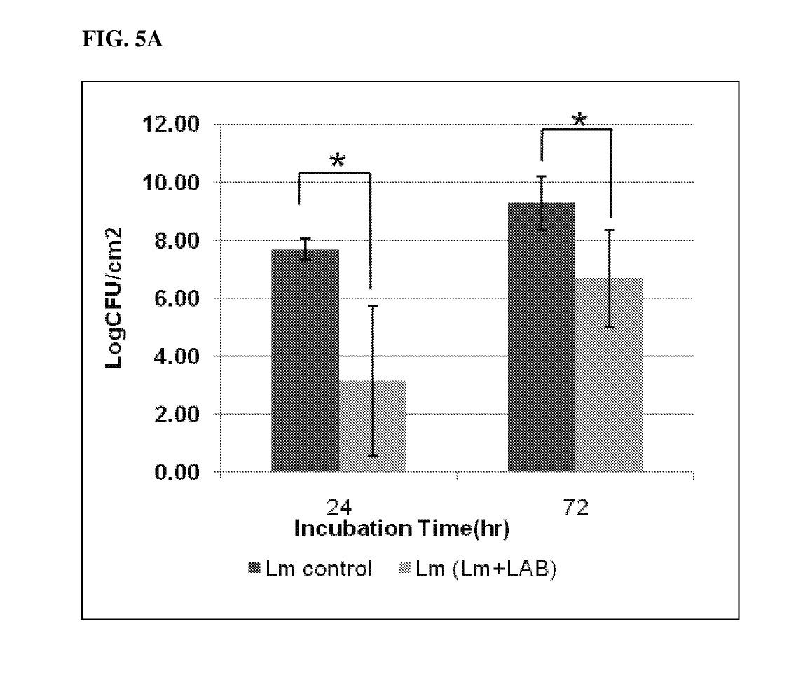

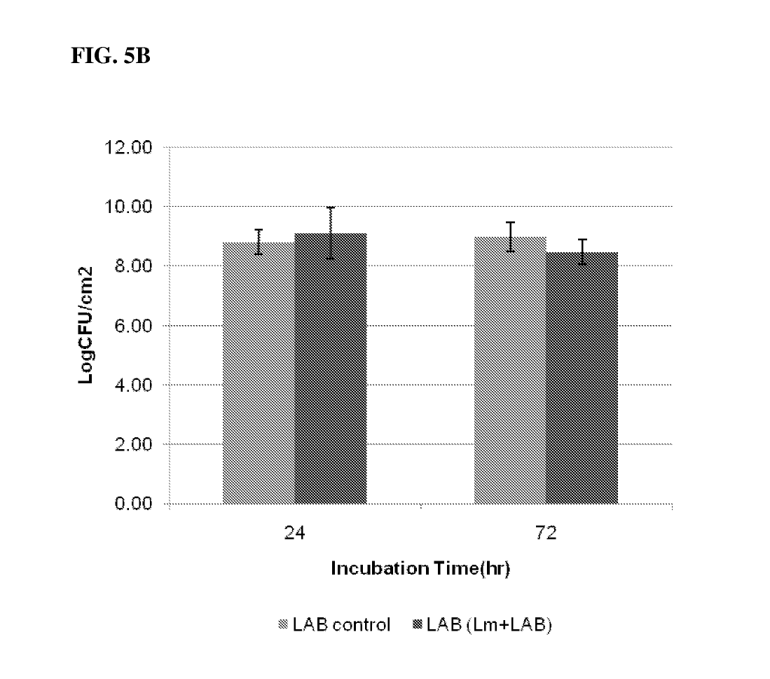

FIG. 5 shows the results of competitive attachment inhibition between L. monocytogenes (10³ CFU/ml) and LAB (10⁸ CFU/ml) on stainless steel. A) L. monocytogenes remained after 24 and 72 hr incubation. Lm (Lm+LAB): L. monocytogenes remained when it was added to the coupons at the same time as LAB. Incubation time is considered from the time after inoculation of LAB and L. monocytogenes B) LAB remained after 24 and 72 hr incubation. LAB (LAB+Lm): LAB remained on the coupons when LAB and L. monocytogenes were added at the same time. Asterisk shows the significant difference (P<0.05).

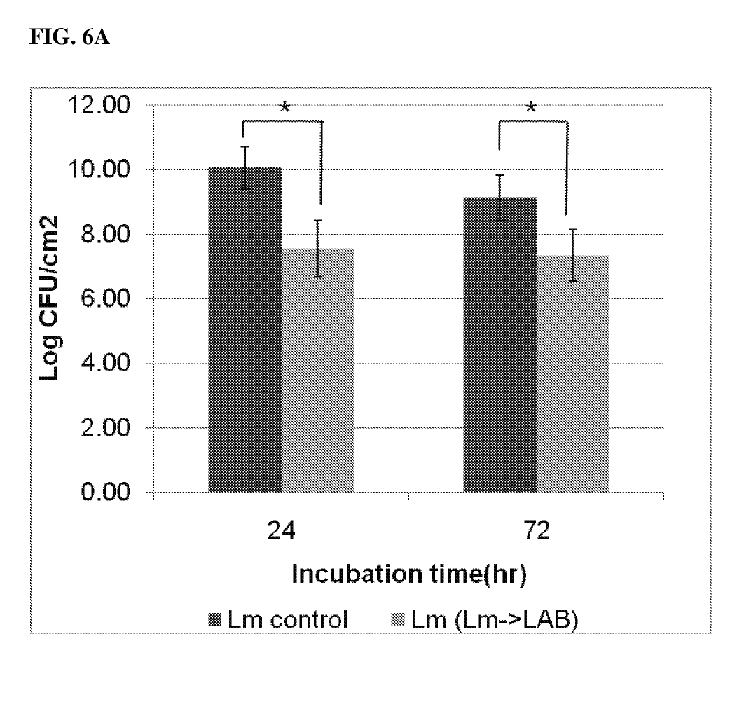

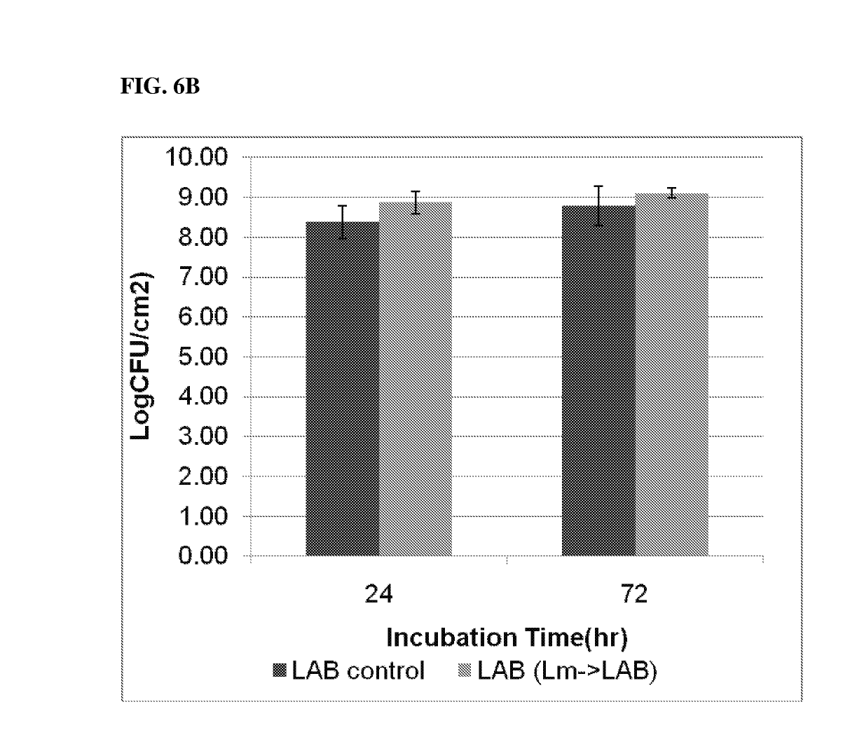

FIG. 6 shows displacement of L. monocytogenes (10³ CFU/ml) by LAB (10⁸ CFU/m1) on stainless steel. L. monocytogenes was pre-treated to the coupons for 24 hr prior to the addition of LAB. A) L. monocytogenes remained after 24 and 72 hr incubation. Lm (Lm→LAB): L. monocytogenes when the coupons were pre-treated with L. monocytogenes for 24 hr prior to the addition of LAB. Incubation time is considered from the time after LAB inoculation. B) LAB remained after 24 and 72 hr incubation. LAB (Lm→LAB): LAB when the coupons were pre-treated with L. monocytogenes 24 hr prior to the addition of LAB. Asterisk shows the significant difference (P<0.05).

These results showed that LAB cocktail (10⁸ CFU/ml) significantly reduced the attachment of L. monocytogenes (10³ CFU/ml) when both organisms were added at the same time on the coupons, and when LAB was added 24 hr prior to the addition of L. monocytogenes. The inhibition was stronger when the coupons were pre-treated with LAB cocktail for 24 hr prior to the addition of L. monocytogenes. The results showed that the inhibition increased over the incubation period. The pre-attached LAB cocktail coated the surface, and effectively prevented L. monocytogenes attachment. LAB was even able to displace L. monocytogenes that was initially allowed to attach on the coupons for 24 hr. On the other hand, LAB cocktail was unaffected with presence of L. monocytogenes on the coupons.

Based on the tests described above, while the optimum LAB concentration for inhibition of L. monocytogenes was about 10⁸ CFU/ml to inhibit the attachment of 10³ CFU/ml L. monocytogenes, about 10⁴ CFU/ml of LAB was able to inhibit the attachment of 10³ CFU/ml L. monocytogenes.

### Example 4

### Specific Inhibition of Listeria by Select Lactic Acid Bacterial Strains

Bacteria culture and maintenance were performed according to standard techniques in the field. More particularly, all bacterial strains (P. acidilactici D3, Lb. amylovorous M35, Lb. animalis La51, and L. monocytogenes 10403S) were stored at −80° C. as glycerol stocks (15% glycerol in either de Man, Rogosa, Sharpe [MRS, EMD Chemicals, Gibbstown, N.J.; LAB strains] or brain heart infusion [BHI, EMD Chemicals; L. monocytogenes] broth). For bacterial growth, MRS (LAB strains) and BHI (L. monocytogenes) broth and agar were prepared according to the manufacturer's instructions. All strains were grown to stationary phase (approx. 22 h) at 37° C. without aeration. For experiments using cell free preparations of the LAB cultures, the desired LAB culture (pre-grown as described above) was centrifuged and the resulting supernatant filter sterilized. Cell free supernatants (CFS) were stored at −20° C.

Spot-on-lawn assays were performed to determine the antimicrobial properties of the three LAB strains against L. monocytogenes. Spot-on-lawn assays were conducted using a modified method previously described (Palmer et al. 2009). Briefly, L. monocytogenes were inoculated into BHI soft agar (0.7%), which had been tempered to 50° C. After thorough mixing, the L. monocytogenes soft agar was poured into sterile Petri plates containing a base layer of BHI agar and allowed to solidify in a laminar flow hood for 30 min. Four μl aliquots of P. acidilactici D3, Lb. amylovorous M35, and Lb. animalis La51 (whole cell cultures or CFS) were then spotted onto the solidified L. monocytogenes soft agar. For control purposes, plates were spotted with 4 μl of MRS broth or 0.01 g/ml nisin (2.5% w/w, prepared in water and filter sterilized immediately prior to use). The diameters of the zones of inhibition were recorded in millimeters. Three biological replicates of spot-on-lawn assays using the whole cell LAB cultures were performed and spot-on-lawn assays using the LAB CFS were performed in duplicate.

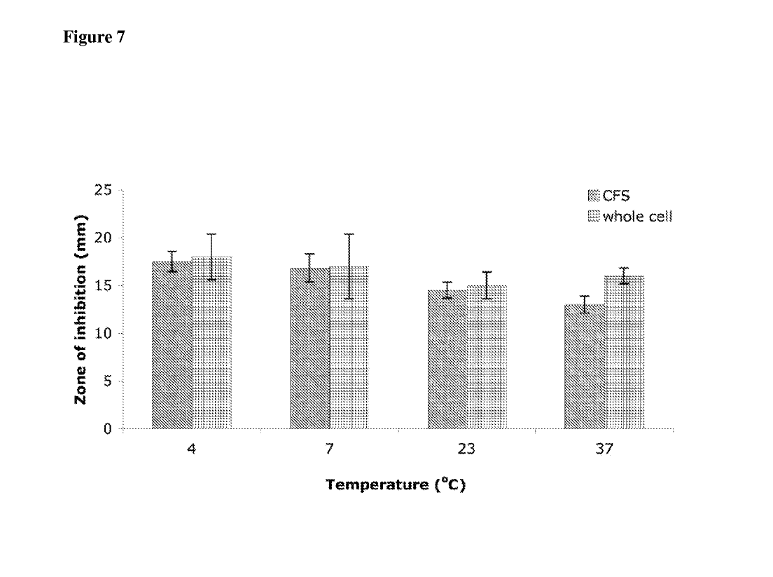

The spot-on-lawn assay results indicated that the P. acidilactici strain had the highest anti-listerial activity (average zone of inhibition diameter 16 mm, Table 1) and there was no substantial difference in its activity across the 4 temperatures tested (FIG. 7). On occasion resistant L. monocytogenes colonies were observed growing within the zones, however, these colonies were rarely observed at the lower temperatures (e.g. 4 and 7° C.) and were most often observed at the highest temperature tested (e.g. 37° C.). Furthermore, there was no substantial difference observed between the effectiveness of the P. acidilactici whole cell culture and the P. acidilactici CFS (FIG. 7). These results suggest that the antimicrobial agent produced by P. acidilactici D3 is secreted.

TABLE 1
Average zones of inhibition (mm ± stdev) from a spot-on-lawn assay
for three LAB strains against L. monocytogenes at 37° C.

| | Spot dilution | | | | |
|---|---|---|---|---|---|
| LAB spotted | 1:1 | 1:2 | 1:4 | 1:8 | 1:16 |
| P. acidilactici | 16 (±0.84) | 15 (±0.55) | 13 (±0.41) | 12 (±0) | 11 (±0) |
| Lb. amylovorous | 0 | 0 | 0 | 0 | 0 |
| Lb. animalis | 0 | 0 | 0 | 0 | 0 |

### Example 5

### Assays to Determine Minimum Inhibitory Concentration (MIC)

MIC assays were performed to evaluate the antimicrobial properties of the three LAB strains using a method complimentary to the spot-on-lawn method described above. MIC assays were performed as previously described (Milillo et al. 2011) with the following modifications. Briefly, 50 μl of sterile BHI broth was added to all test wells in a 96 well plate. Next, 50 μl of each LAB CFS was added to the first well (row A) of each column; then, serial 1:2 dilutions were performed down to the last row (H). This arrangement allowed for the testing of CFS dilutions of 1:4 (row A), 1:8 (B), 1:16 (C), 1:32 (D), 1:64 (E), 1:128 (F), 1:256 (G), and 1:512 (H). At this point, for the 7° C. MIC experiments, the 96 well plate was transferred to 4° C. to pre-chill the dilutions. Once the plate has been completely chilled, 50 μl of stationary phase L. monocytogenes (5×10⁵ CFU) freshly re-suspended in pre-chilled BHI broth was added to all test wells. For 23° C. MIC experiments, all solutions and cultures were utilized at room temperature. MRS broth, BHI broth, 0.01 g/ml nisin (prepared as described above), and MRS broth adjusted to pH 4 (using conc. lactic acid) served as controls. The 96 well plate was then incubated at 7° C. or 23° C., as appropriate, and the optical density results were recorded at 595 nm using a plate reading spectrophotometer with the automatic mixing function enabled (BioRad Model 3550 Microplate Reader; BioRad, Hercules, Calif.). The LAB CFS MIC was defined as the lowest concentration of LAB CFS that restricted L. monocytognes growth to an optical density<0.05. MIC assays were performed in duplicate.

CFS for all three LAB strains was tested, and only the P. acidilactici CFS was effective at inhibiting L. monocytogenes growth over a wide range of concentrations (up to a 1:512 dilution when exposure occurred for a short time [i.e. for 24 h at 23° C. or 12 days at 7° C.]). However, over a longer course of exposure (i.e. 48 h at 23° C. or 32 days at 7° C.) L. monocytogenes inhibition was limited to only the highest concentration of P. acidilactici CFS tested for either temperature (i.e. 1:4). Even though no L. monocytogenes inhibition was observed for Lb. animalis and Lb. amylovorous with the spot-on-lawn assay, some L. monocytogenes inhibition was observed in the MIC assay. The amount of inhibition was similar to that observed for the control (pH 4 MRS), suggesting that the low pH of the LAB CFS itself may be inhibitory to L. monocytogenes. This mechanism is likely because pH 4.3 has been shown to be the minimum pH for L. monocytogenes growth (George et al. 1988).

### Example 6

### Assays to Determine L. monocytogenes Cell Survival

With the MIC established, L. monocytogenes survival assays were performed at 7° C. for 21 days to determine if the LAB CFS simply inhibited L. monocytogenes growth (e.g. was bacteriostatic) or was bacteriocidal. The LAB strain/CFS concentration found most effective at inhibiting L. monocytogenes in the MIC assays (i.e. 1:4) was further examined for L. monocytogenes cell survival to determine whether the LAB CFS was bacteriocidal. L. monocytogenes (approximately 1×10⁶ CFU/ml) incubating in LAB CFS (prepared as described above) at 7° C. was serially diluted in sterile phosphate buffered saline (PBS) and plated onto BHI agar for the duration of the experiment. Three biological replicates of the survival assays were performed.

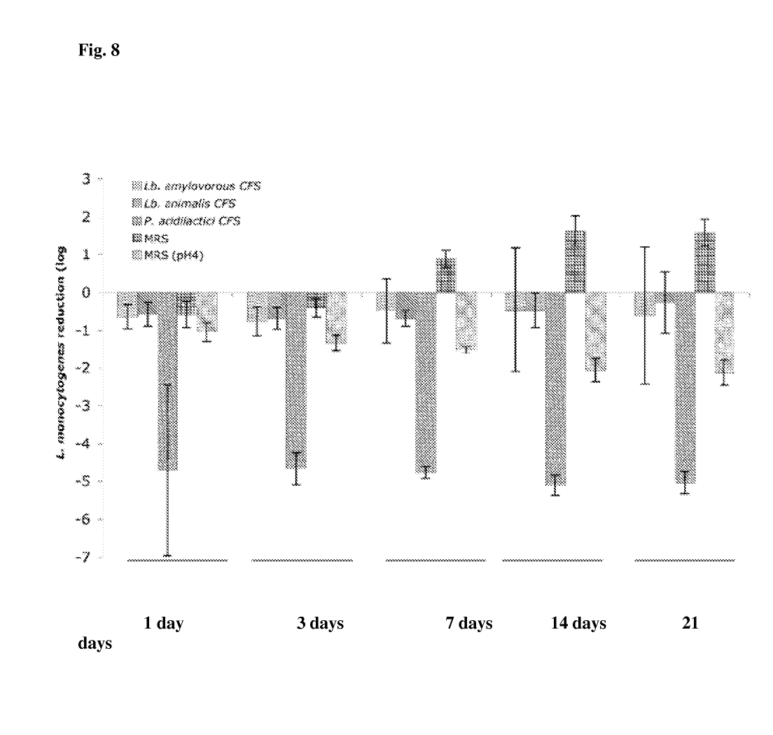

Consistent with the mild inhibition observed in the MIC assay, the survival assay results show that when exposed to Lb. animalis and Lb. amylovorous CFS L. monocytogenes may initially decrease slightly but over time its numbers were stable (FIG. 8). L. monocytogenes exposed to the P. acidilactici CFS was reduced by nearly 5 logs within 24 h with a low level of L. monocytogenes surviving for the duration of the experiment. For control purposes, glucose (20 g/L, the same amount as in MRS broth) was added to the LAB CFS in order to compensate for the glucose consumed by the LAB during growth. The addition of glucose was not observed to alleviate L. monocytogenes inhibition (data not shown), indicating that its inhibition during exposure to LAB CFS was not due to a lack of nutrients available for growth.

Interestingly, these data also demonstrate that though resistance of L. monocytogenes to P. acidilactici CFS had previously been observed in the spot-on-lawn assays, resistance was not observed during the survival assay. L. monocytogenes is known to be able to develop resistance to bacteriocins produced by P. acidilactici (Gravesen et al. 2002) but studies have shown it to be effective against L. monocytogenes at 4° C. (Nielsen et al. 1990, Uhart et al. 2004, Youssef et al. 1991). Thus, it is possible that the observed lack of resistance was due to the low temperature at which the survival assays were conducted as well as the significant contribution of the acidic pH (see pH 4 MRS control; FIG. 8). This is consistent with results from the spot-on-lawn assay which indicated that spontaneous resistance occurred much less frequently for the spot-on-lawn assays conducted at 4 and 7° C. as compared to assays at higher temperature.

### Example 7

### Determination of LAB Components Required for Inhibition

Experiments were performed to determine factors that may contribute to the LAB inhibition of L. monocytogenes. The following conditions were tested to evaluate their contribution to L. monocytogenes inhibition: (i) pH; (ii) heat stability; and (iii) protease sensitivity. To determine the effect of pH on L. monocytogenes inhibition, the LAB CFS pH (routinely measured at approx. 4) was adjusted to 7 using 1 N NaOH and the CFS re-filter sterilized prior to use. The effects of the pH-adjusted LAB CFS on L. monocytogenes inhibition were measured using the MIC experimental design described above.

Heat stability and protease sensitivity treatments were performed as described previously (Rea et al. 2010) and with the following changes. For heat treatment, P. acidilactici CFS was exposed to temperatures ranging from 40 to 100° C. for 15 to 90 min in a circulating water bath, as well as 121° C. for 15 to 90 min at 15 psi (standard autoclave temperature and pressure). For protease treatment, P. acidilactici CFS was exposed to 25 mg/ml proteinase K for 1 h at 37° C. The effects of the heat and protease treatments on L. monocytogenes inhibition were subsequently evaluated using the spot-on-lawn method described above. In addition, lactic acid production by the 3 LAB strains was measured using their corresponding CFS and a colorimetric lactate dehydrogenase activity kit according to the manufacturer's instructions (BioVision, Inc., San Francisco, Calif.).

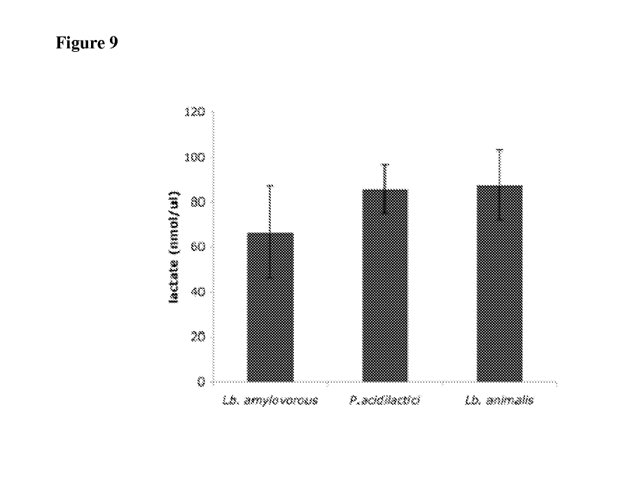

While pH may be one factor that contributes to the anti-listerial activity, it may not be the main contributing factor of P. acidilactici's anti-listerial activity. Although the three LAB strains have very different effects on L. monocytogenes in the spot-on-lawn and MIC assays, all three LAB strains were found to produce approximately the same amount of lactate (p>0.05, FIG. 9). To lend support to the hypothesis that pH is not the only antilisterial mechanism, the LAB CFS pH (normally approximately 4) were adjusted with 1N NaOH to approximately 7 and L. monocytogenes was subsequently exposed to the pH neutral CFS using the MIC experimental method described above. After 24 h of incubation at 23° C., a 1:4 dilution of CFS from Lb. amylovorous and P. acidilactici, but not Lb. animalis were inhibitory to L. monocytogenes. However, unlike the non-pH adjusted CFS, none of the pH adjusted LAB CFS were inhibitory after 48 h of exposure. These data confirm that pH is not the only antilisterial mechanism of action for at least Lb. amylovorous and P. acidilactici.

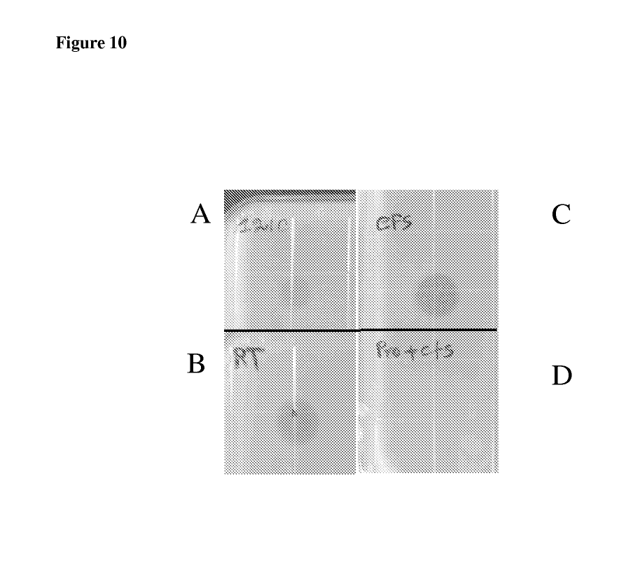

As P. acidilactici was by far the most antilisterial of the three LAB, the source of its antimicrobial activity was further investigated by examining its heat and protease stability using spot-on-lawn assays with heat and protease treated CFS. P. acidilactici CFS maintained full activity following all thermal treatments tested (data not shown). Relative to the room temperature control, it maintained some activity following autoclaving (121° C. and 15 psi) for 15 min (FIGS. 10A & 10B), and activity was undetectable after autoclaving for 90 min (data not shown). In addition, P. acidilactici CFS lost activity following exposure to proteinase K (FIGS. 10C & 10D). Heat stability in combination with protease sensitivity is a common characteristic of class II bacteriocins, which P. acidilactici has been shown to sometimes possess (Miller et al. 2005). Analysis with PCR to detect the papA gene, which encodes the pediocin ACH/PA-1 preprotein, confirmed that P. acidilactici D3 contains this gene (unpublished data).

P. acidilactici and pediocin ACH/PA-1, the bacteriocin commonly produced by P. acidilactici, has been studied for use against L. monocytogenes but typically studies have only examined using P. acidilactici as a whole cell culture or the purified pediocin (Allende et al. 2007, Bari et al. 2005, Buyong et al. 1998, Foegeding et al. 1992). However, there are several drawbacks to using either of these approaches, including: reliance on P. acidilactici survival and in situ pediocin production; lack of commercially available pediocin; confirmation of pediocin activity in situ; and labeling requirements for purified chemicals. For use in food products at high risk for L. monocytogenes contamination, especially those where in situ pediocin production by P. acidilactici might not be possible (e.g. non-fermented foods) and those where in situ pediocin activity might be effected by the surrounding food matrix, using P. acidilactici CFS represents a natural alternative. Moreover, scattered reports exist documenting the potential for use of P. acidilactici CFS for control of L. monocytogenes in dairy products and ground beef (Hartman et al. 2011, Pucci et al. 1988).

In conclusion, of the three LAB strains tested, the P. acidilactici strain was the most effective at inhibiting L. monocytogenes growth and produced up to a 4.5 log reduction in L. monocytogenes numbers in vitro. The source of P. acidilactici CFS effectiveness against L. monocytogenes was shown to be a combination of properties that specifically target L. monocytogenes (i.e. bacteriocin production) and are generally antimicrobial (i.e. acidic pH). Together, these data indicate that P. acidilactici CFS may represent an effective, natural control method for L. monocytogenes in food products.

### REFERENCES

All references cited throughout the text or listed below are hereby incorporated into this disclosure as if fully reproduced herein.
Amezquita, A.; Brashears, M. M. 2002. Competitive inhibition of Listeria monocytogenes in ready-to-eat meat products by lactic acid bacteria J. Food Prot. 65(2) 316-325.
Chae, M. S.; Shraft, H.; Hansen, L. T.; Mackereth, T. 2006. Effects of physicochemical surface characteristics of Listeria monocytogenes strains on attachment to glass. Food Microb. 23(3) 250-259.
Cossart, P.; Toledo-Arana, A. 2008. Listeria monocytogenes, a unique model in infection biology: an overview. Microb. infect. 10(9)1041-1050.
Moretro, T.; Langsrud, T. 2004. Listeria monocytogenes: biofilm formation and persistence in food-processing environments. Biofilms. 1, 107-121.
Pan, Y.; Breidt, F.; Gorski, L. 2010. Synergistic effects of sodium chloride, glucose, and temperature on biofilm formation by Listeria monocytogenes serotype 1/2a and 4b strains. Applied. Environ. Microb. 76(5) 1433-1441.
Scallan, E.; Hoekstra, R. M.; Angulo, F. J.; Tauxe, R. V.; Widdowson, M. A.; Roy, S. L.; Jones, J. L.; Griffin, P. M. 2011. Foodborne illness acquired in the United States—major pathogens. Emerg. Infect. Dis. Centers of Disease Control and prevention. 17(1):7-15
Scharff, R L. “Health-related costs from foodborne illness in the United States.” (2010). The produce Safety Project at Georgetown University. Available from www.producesafetyproject.org.
Allende, A., Martinez, B., Selma, V., Gil, M. I., Suarez, J. E., and Rodriguez, A. 2007. Growth and bacteriocin production by lactic acid bacteria in vegetable broth and their effectiveness at reducing Listeria monocytogenes in vitro and in fresh-cut lettuce. Food Microbiol. 24, 759-766.
Amezquita, A., and Brashears, M. M. 2002. Competitive inhibition of Listeria monocytogenes in ready-to-eat meat products by lactic acid bacteria. J. Food Prot. 65, 316-325.
Bari, M. L., Ukuku, D. O., Kawasaki, T., Inatsu, Y., Isshiki, K., and Kawamoto, S. 2005. Combined efficacy of nisin and pediocin with sodium lactate, citric acid, phytic acid, and potassium sorbate and EDTA in reducing the Listeria monocytogenes population of inoculated fresh-cut produce. J. Food Prot. 68, 1381-1387.
Batz, M. B., Hoffman, S., and Morris Jr., J. G. 2011. Ranking the risks: The 10 pathogen-food combinations with the greatest burden on public health. Emerging Pathogens Institute, University of Florida, Gainesville, Fla. Available at: http://www.rwjf.org/files/research/72267report.pdf Accessed 13 Mar. 2012.
Buyong, N., Kok, J. and Luchansky, J. B. 1998. Use of a genetically enhanced, pediocin-producing starter culture, Lactococcus lactis subsp. lactis MM217, to control Listeria monocytogenes in cheddar cheese. Appl. Environ. Microbiol. 64, 4842-4845.
Eijsink, V. G., Axelsson, L., Diep, D. B., Havarstein, L. S., Holo, H. and Nes, I. F. 2002. Production of class II bacteriocins by lactic acid bacteria; an example of biological warfare and communication. Antonie van Leeuwenhoek. 81, 639-654.
Foegeding, P. M., Thomas, A. B., Pilkington, D. H. and Klaenhammer, T. R. 1992. Enhanced control of Listeria monocytogenes by in situ-produced pediocin during dry fermented sausage production. Appl. Environ. Microbiol. 58, 884-890.
George, S., Lund, B. and Brocklehurst, T. 1988. The effect of pH and temperature on initiation of growth of Listeria monocytogenes. Lett. Appl. Microbiol. 6, 153-156.
Gravesen, A., Jydegaard Axelsen, A. M., Mendes da Silva, J., Hansen, T. B. and Knochel, S. 2002. Frequency of bacteriocin resistance development and associated fitness costs in Listeria monocytogenes. Appl. Environ. Microbiol. 68, 756-764.
Hartmann, H. A., Wilke, T. and Erdmann, R. 2011. Efficacy of bacteriocin-containing cell-free culture supernatants from lactic acid bacteria to control Listeria monocytogenes in food. Int. J. Food Microbiol. 146, 192-199.
Masood, M. I., Qadir, M. I., Shirazi, J. H. and Khan, I. U. 2011. Beneficial effects of lactic acid bacteria on human beings. Crit. Rev. Microbiol. 37, 91-98.
Milillo, S. R., Martin, E., Muthaiyan, A. and Ricke, S. C. 2011. Immediate reduction of Salmonella enterica serotype Typhimurium viability via membrane destabilization following exposure to multiple-hurdle treatments with heated, acidified organic acid salt solutions. Appl. Environ. Microbiol. 77, 3765-3772.
Miller, K. W., Ray, P., Steinmetz, T., Hanekamp, T., and Ray, B. 2005. Gene organization and sequences of pediocin AcH/PA-1 production operons in Pediococcus and Lactobacillus plasmids. Lett. Appl. Microbiol. 40, 56-62.
Nielsen, J. W., Dickson, J. S. and Crouse, J. D. 1990. Use of a bacteriocin produced by Pediococcus acidilactici to inhibit Listeria monocytogenes associated with fresh meat. Appl. Environ. Microbiol. 56, 2142-2145.
Palmer, M. E., Wiedmann, M. and Boor, K. J. 2009. Sigma(B) and sigma(L) contribute to Listeria monocytogenes 10403S response to the antimicrobial peptides SdpC and nisin. Foodborne Pathog. Dis. 6, 1057-1065.
Pucci, M. J., Vedamuthu, E. R., Kunka, B. S. and Vandenbergh, P. A. 1988. Inhibition of Listeria monocytogenes by using bacteriocin PA-1 produced by Pediococcus acidilactici PAC 1.0. Appl. Environ. Microbiol. 54, 2349-2353.
Rea, M. C., Sit, C. S., Clayton, E., O'Connor, P. M., Whittal, R. M., Zheng, J., Vederas, J. C., Ross, R. P. and Hill, C. 2010. Thuricin CD, a posttranslationally modified bacteriocin with a narrow spectrum of activity against Clostridium difficile. PNAS. 107, 9352-9357.
Taormina, P. J. 2010. Implications of salt and sodium reduction on microbial food safety. Crit Rev Food Sci Nut. 50, 209-227.
Uhart, M., Ravishankar, S. and Maks, N. D. 2004. Control of Listeria monocytogenes with combined antimicrobials on beef franks stored at 4 degrees C. J. Food Prot. 67, 2296-2301.
Yousef, A. E., Luchansky, J. B., Degnan, A. J. and Doyle, M. P. 1991. Behavior of Listeria monocytogenes in wiener exudates in the presence of Pediococcus acidilactici H or pediocin AcH during storage at 4 or 25 degrees C. Appl. Environ. Microbiol. 57, 1461-1467.

What is claimed is:

1. A method for improving food safety, said method comprising a step of contacting a surface with a composition, said composition comprising at least one lactic acid producing microorganism, said at least one lactic acid producing microorganism being present in said composition in an amount effective in preventing or disrupting formation of biofilm by a pathogenic bacterium on said surface, wherein said surface is the interior or exterior surface of an object, said object being selected from the group consisting of a food material, a food processing equipment, a food processing platform, a food processing tool, a food processing room, a food container, and combination thereof.

2. The method of claim 1, wherein said composition comprises three lactic acid producing microorganisms, said three lactic acid producing microorganisms being NP3, NP35 and NP51.

3. The method of claim 1, wherein said composition consists essentially of three lactic acid producing microorganisms, said three lactic acid producing microorganisms being NP51, NP35 and NP3.

4. The method of claim 1, wherein said surface is the surface of a food material.

5. The method of claim 1, wherein said food material is selected from meat, a meat product, seafood, a seafood product, a plant material, milk from an animal, milk derived from a plant material, and combination thereof.

6. The method of claim 1, wherein said surface is the surface of a food processing equipment, a food processing platform, or a food container.

7. The method of claim 1, wherein at least 10% of the at least one lactic acid producing microorganism is attached to said surface within 72 hours after being applied to the surface.

8. The method of claim 1, wherein said at least one lactic acid producing microorganism is present in said composition in an amount effective in inhibiting growth of said pathogenic bacterium.

9. The method of claim 1, wherein said at least one lactic acid producing microorganism further inhibits growth of a non-bacterial pathogen.

10. The method of claim 1, wherein said pathogenic bacterium is Listeria monocytogenes.

11. A method for reducing the amount of a pathogen in a food material, said method comprising:
contacting said food material with a composition, said composition comprising at least one lactic acid producing microorganism, said at least one lactic acid producing microorganism being present in said composition in an amount effective in reducing the number of said pathogen in said food material.

12. The method of claim 11, wherein said composition comprises a lactic acid producing microorganisms selected from the groups consisting of NP3, NP35 and NP51.

13. The method of claim 11, wherein said composition comprises a lactic acid producing microorganism NP3.

14. The method of claim 11, wherein said effective amount is an amount effective in reducing the number of said pathogenic bacterium in said food material by at least 2 logs within 24 hours after said contacting step.

15. The method of claim 11, wherein said effective amount is an amount effective in reducing the number of said pathogenic bacterium in said food material by at least 4 logs within 24 hours after said contacting step.

16. The method of claim 11, wherein said pathogen is Listeria monocytogenes.

17. A method for reducing the amount of a pathogen in a food material, said method comprising:
contacting said food material with a composition, said composition comprising a cell-free supernatant (CSF) obtained from at least one lactic acid producing microorganism, said CSF being present in said composition in an amount effective in reducing the number of said pathogen in said food material.

18. The method of claim 17, wherein said composition comprises a lactic acid producing microorganism NP3.

19. The method of claim 17, wherein said effective amount is an amount effective in reducing the number of said pathogenic bacterium in said food material by at least 2 logs within 24 hours after said contacting step.

20. The method of claim 17, wherein said effective amount is an amount effective in reducing the number of said pathogenic bacterium in said food material by at least 4 logs within 24 h after said contacting step.

21. The method of claim 17, wherein said cell-free supernatant (CSF) is diluted by at least 1:100 after being separated from said lactic acid producing microorganism but before contacting said food material.

22. The method of claim 17, wherein said pathogen is Listeria monocytogenes.

23. A composition comprising a cell-free supernatant (CFS) obtained from a lactic acid bacterium.

24. The composition of claim 23, said composition further comprises a lactic acid bacterium.
